(19) United States
(12) Patent Application Publication
(10) Pub. No.: US 2016/0057094 A1
(43) Pub. Date: Feb. 25, 2016

(54) METHOD AND SYSTEM FOR MAINTAINING AND MANAGING SOCIAL CAPITAL

(71) Applicant: IntellectSpace Corporation, Seattle, WA (US)

(72) Inventor: Aleksandr Gvelesiani, Bothell, WA (US)

(21) Appl. No.: 14/811,547

(22) Filed: Jul. 28, 2015

Related U.S. Application Data
(60) Provisional application No. 62/030,010, filed on Jul. 28, 2014.

(51) Int. Cl. H04L 12/58; G06F 3/0484; G06F 17/30; H04L 29/08

(52) U.S. Cl. CPC H04L 51/32; H04L 67/02; H04L 67/306; G06F 3/04842; G06F 17/3053; H04L 51/04

(57) ABSTRACT

Methods, systems, and techniques managing a user's social capital to maximize his or her networking potential are provided. Example embodiments provide a SoCap application and tools to manage and maximize a user's capital. In one embodiment, the SoCap application facilitates making, managing, and/or nurturing connections through relationships with one or more individuals or business entities. Each entity is associated with an influence score that reflects, for example, the entity's connections to other entities, the strength of those connections, and the importance of the entity's affiliations with companies. In some embodiments, the SoCap application is a web-based application that leverages contacts from electronic mail applications, phone devices, social networks, professional networks, and CRM applications.

### CROSS-REFERENCE TO RELATED APPLICATIONS

This Application claims the benefit of U.S. Provisional Application No. 62/030,010, entitled “METHOD AND SYSTEM FOR MAINTAINING AND MANAGING SOCIAL CAPITAL,” filed Jul. 28, 2014, which is incorporated herein by reference in its entirety.

### TECHNICAL FIELD

The present disclosure relates to methods, techniques, and systems for managing social capital and, in particular, to methods, techniques, and systems for maximizing connections to users and entities.

### BACKGROUND

In today's highly computer connected environments, it is difficult for users to understand, manage, and maintain their connections to other users, companies, and the like. For example, a user may be connected to thousands of other people through various contact lists and applications. For example, a user's email contact list may be oriented to one set of contact lists and a user's social network applications, such as FACEBOOK and LINKEDIN, may provide access to the same or a different set of contacts and connections. In addition, a user's connections via social networks may be indirect such as second or third level connections of the people the user is connected to.

In addition, many organizations and users, for example professional users who are engaged in business-to-business commerce, constantly look for ways in which they can leverage their existing networks to reach and engage prospective business and social opportunities. In order to identify efficient ways to reach and engage others, such users often analyze their own professional networks to determine whether they share any mutual connections with business opportunities that they wish to develop. For the purpose of this description, the process of determining and exploring connections will be referred to as “Relationship Mapping.”

The principles of Relationship Mapping have been applied to a wide range of professional activities, including but not limited to sales, business development, fundraising, investor relations, prospect development, marketing, channel development, competitive intelligence, and business intelligence. Although the benefits of leveraging existing professional relationships to develop new business opportunities have been well documented, the sheer volume of information involved and a lack of automated techniques have rendered the process of Relationship Mapping as manual, laborious and often incomplete.

### BRIEF DESCRIPTION OF THE DRAWINGS

FIG. 1 is a block diagram illustrating example components of a Social Capital Management System.

FIG. 2 is an example screen display from an example SoCap embodiment of a profile of a person the user knows or cares to meet.

FIG. 3 is an example screen display from an example SoCap embodiment of a dashboard page of the logged-in User.

FIG. 4 is an example screen display from an example SoCap embodiment of a User's Contacts to a set of target opportunities.

FIG. 5 shows detailed information about each relationship path, to help the User determine which path to choose, in an attempt to reach a prospect.

FIG. 6 is an example flow diagram of logic for determination of an Influence Score in an example SoCap embodiment.

FIG. 7 is an example block diagram of an example computing system that may be used to practice embodiments of a Social Capital Management System described herein.

### DETAILED DESCRIPTION

Embodiments described herein provide enhanced computer—and network-based methods, techniques, and systems for managing a user's social capital to maximize his or her networking potential. Networking potential refers to the potential for making, managing, and/or nurturing existing and future connections through relationships with one or more individuals or business entities. Relationship mapping to discover connections may comprise at least one part of this process. Connections may be further made through these relationships even if they involve relationships not yet currently discovered.

Example embodiments provide a web-based social capital management solution (“SoCap”), which empowers users to take account of their social capital and maximize their networking potential. SoCap helps users take inventory of their contacts, track engagement with their network (of people and entities), research everyone's level of influence, and map warm paths to new opportunities. Users may be, for example, individual users, professionals, and/or teams of people.

The SoCap application comprises algorithms and a web interface (e.g., provided by a web service, web application, or the like). Although referred to herein as a web-based (e.g., Internet based) solution, other configurations that implement SoCap over other communication network models or within an intranet or a monolithic system are also contemplated.

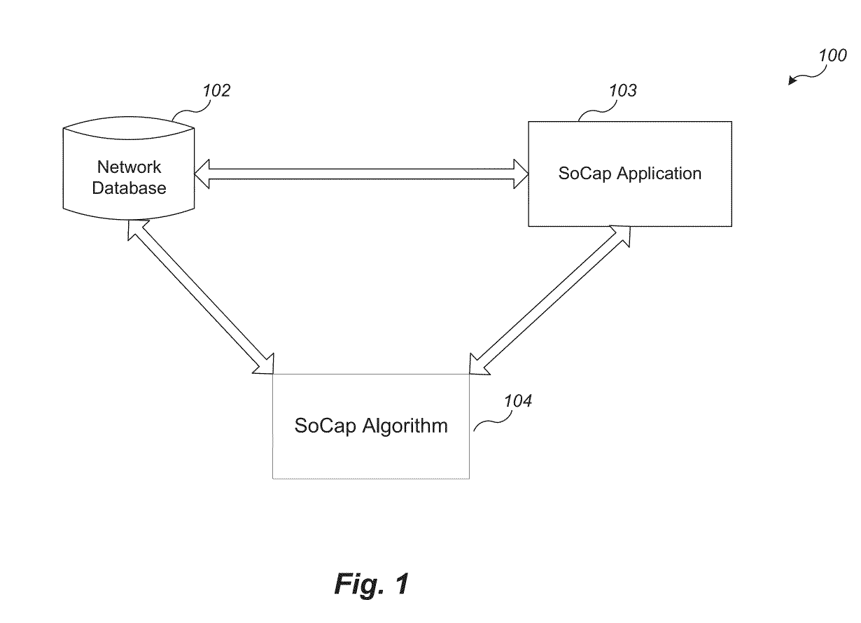

FIG. 1 is a block diagram illustrating example components of a Social Capital Management System (SoCap). SoCap comprises one or more SoCap algorithms 104, a SoCap (web) service or application 103, and some memory for storing information regarding the SoCap connections, such as Network Database 102.

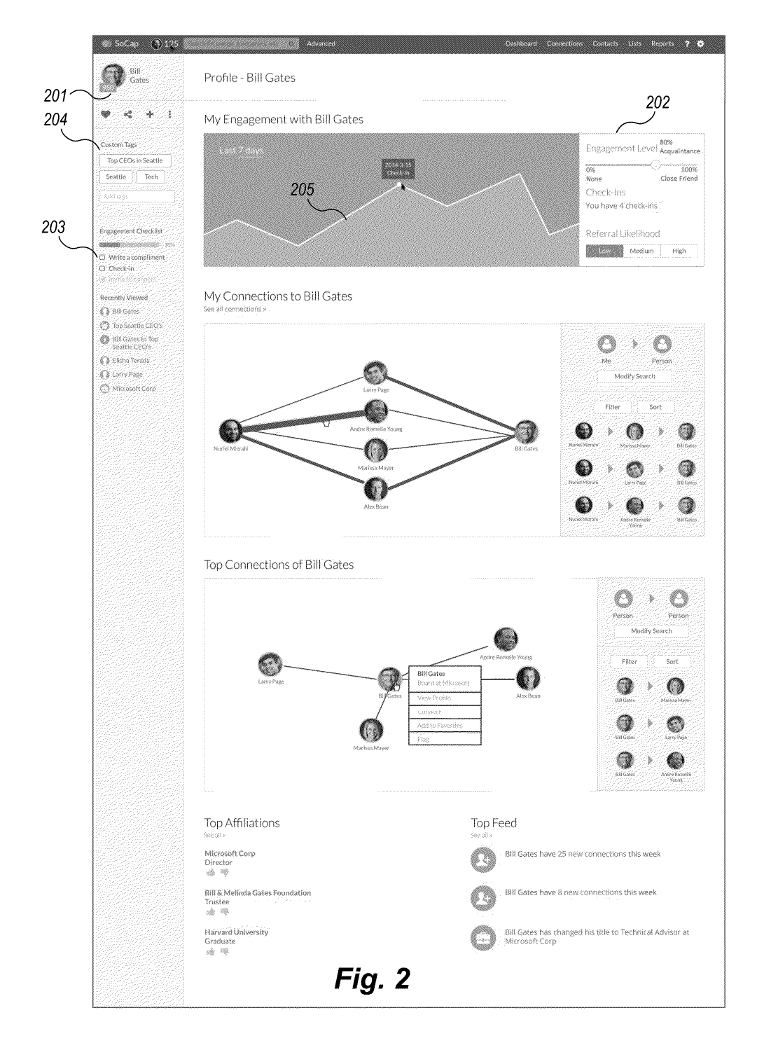

FIG. 2 is an example screen display from an example SoCap embodiment of a profile of a person the user knows or cares to meet. In FIG. 2, the display shows a profile of a person, Bill Gates, who is deemed by the SoCap user (“User”) to be a SoCap contact (“Contact”)—someone that the user knows or cares to meet. To achieve this, the User can import his or her contacts from other sources (such as Outlook, CRM, LinkedIn, Facebook, Phone Contacts, etc.) or search for persons in the SoCap database and classify them as a contact. Unlike a social network such as Facebook or LinkedIn, this operation does not require the person being classified as an existing contact to acknowledge the action. (The Contact may be someone the User wishes to be connected to but is not yet someone with whom the User has been in contact.)

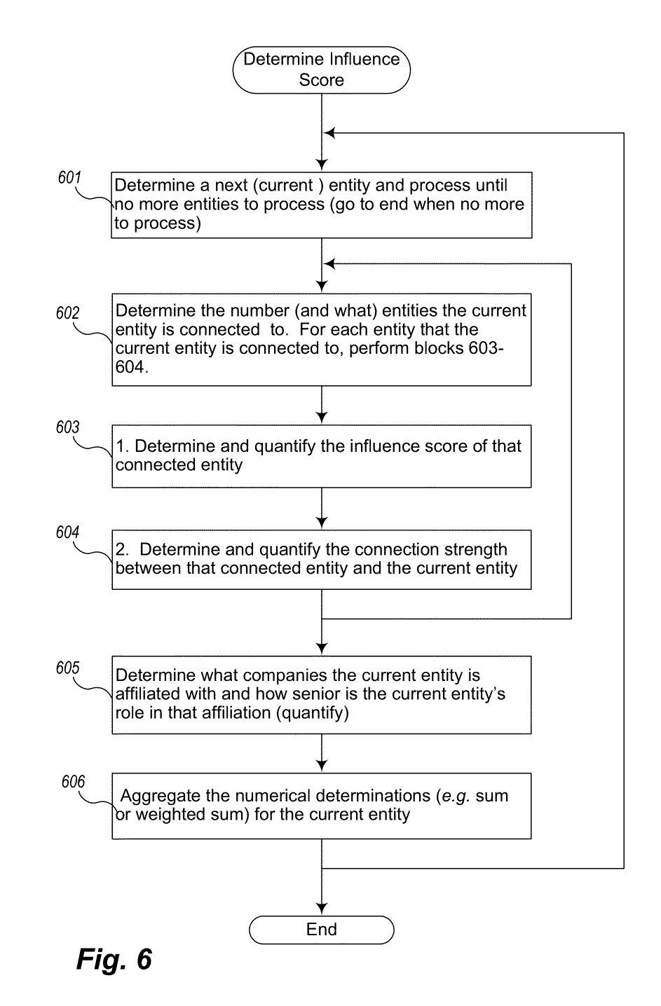

On the top left corner shows Bill Gates's level of influence score 101 (“Influence Score”) to be “950.” This Influence Score 101 is calculated for every person in the SoCap database, and indicates the level of that person's influence represented here as a numeric value. Other embodiments may provide other indicators of influence such as a graphical display, icon, descriptor, or the like. The Influence Score algorithm is discussed below with respect to FIG. 6.

Top right section also shows a slider control 202 that lets the User set the engagement level (“Engagement Level”) with this Contact (existing or desired connection) to a specific numerical value (such as 80%) and/or to a specific classification value (such as an Acquaintance, Close Friend, or the like). The Engagement Level relative to the User may change over time, and SoCap will track the historical engagement level, as shown on with the line chart 205 in FIG. 2.

In addition to setting the “Engagement Level”, the User can track specific actions (“Engagement Action(s)”) 203 that promote increased engagement with a particular Contact. As shown on the left-hand side of the FIG. 2 under actions 203, a User can indicate various actions completed with the Contact, such as: held a meeting, had coffee together, shared a dinner, traveled together.

A User can also categorize the contact, as shown on the top left section of FIG. 2 under “Custom Tags” 204. Example indications include: position in community, which community, what area of specialty, etc.

A User can map warm paths, or mutual connections, between the Contact and him or herself, as shown in the middle section of FIG. 2 under “Top Connections to Bill Gates”.

As shown on the bottom of FIG. 2, a User can see the Contact's professional Contacts, professional affiliations, and an activity history (or feed).

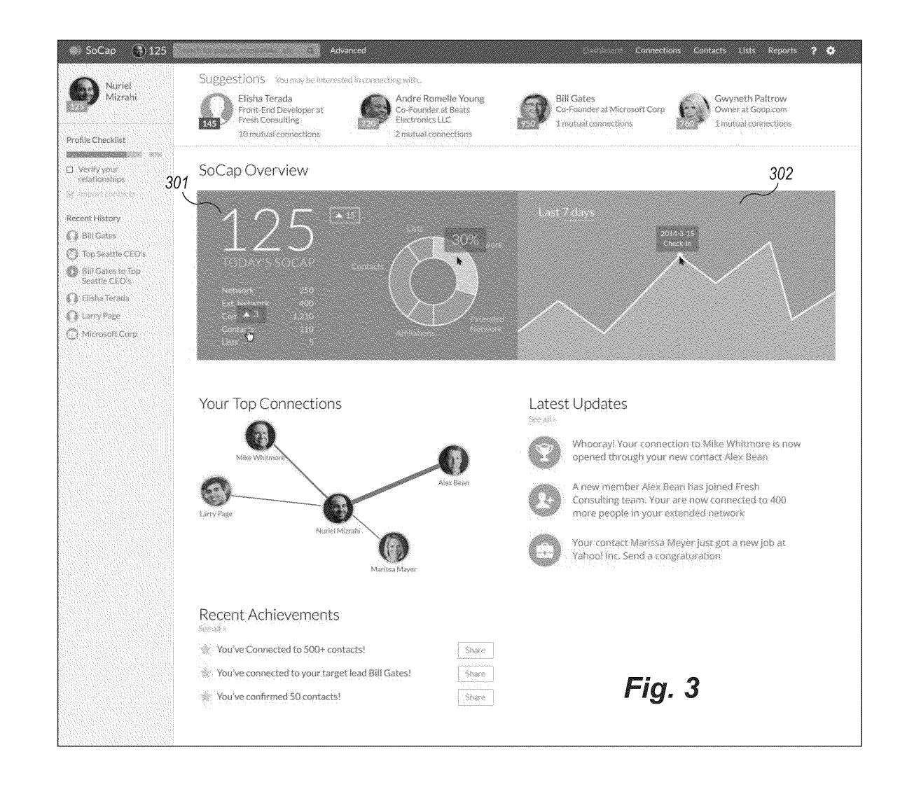

FIG. 3 is an example screen display from an example SoCap embodiment of a dashboard page of the logged-in User. The dashboard page prominently displays the User's own Influence Score 301, here “125.” The Influence Score 301 is calculated by taking into account the Influence Scores of the User's Contacts, as well as the Engagement Levels to each of the User's Contacts. The User's Influence Score will update, for example, in the event that the User adds more influential Contacts, the User increases a Level of Engagement with existing contacts, or the Contacts' own Influence Score rises. FIG. 3 also shows a chart 302 that tracks the User's Influence Score over time. Other forms for tracking the history of the User's Influence Score may also be incorporated.

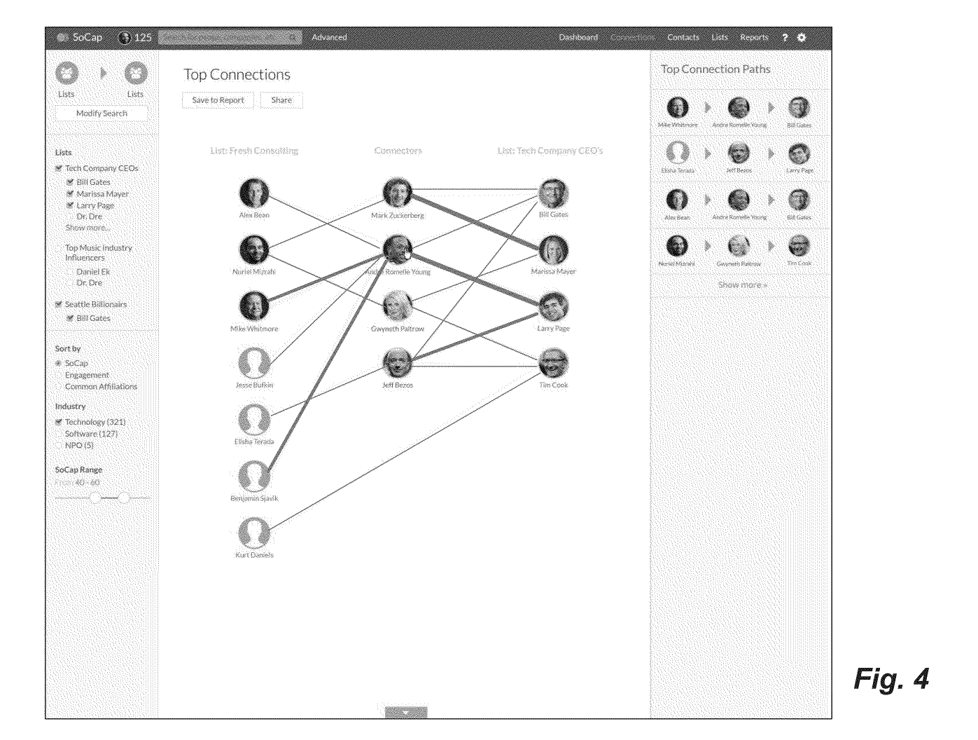

FIG. 4 is an example screen display from an example SoCap embodiment of a User's Contacts to a set of target opportunities. These Contacts may be discovered via Relationship Mapping, by harvesting existing contacts from the User's various social and professional networks, and/or by other means.

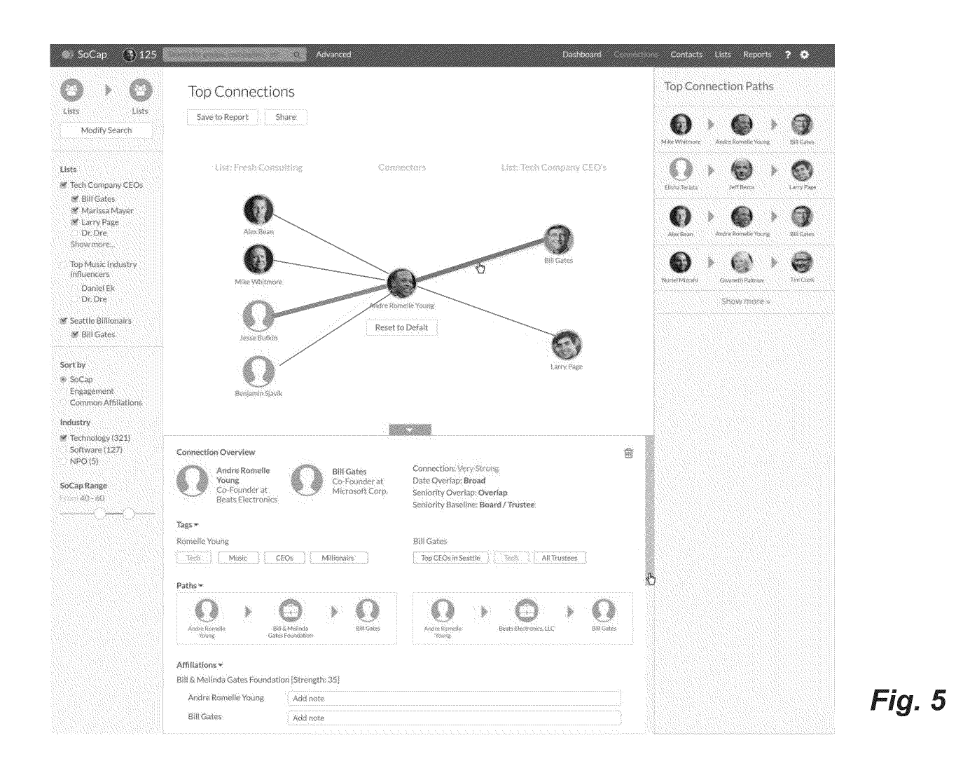

FIG. 5 shows detailed information about each relationship path, to help the User determine which connection path to choose, in an attempt to reach a prospect. In the example displayed, the User is looking at details of a relationship path between Andre Romelle Young and Bill Gates, in an effort to form a connection with Bill Gates. Here Andre Romelle Young would be serving as a “Connector.” The User may already be connected with Andre Romelle Young or have a connection to him.

FIG. 6 is an example flow diagram of logic for determination of an Influence Score in an example SoCap embodiment. An influence score is calculated for every User, Contact, and Person (an “Entity”) in the SoCap database, by taking into account the following factors:

1) How many other Entities is the current Entity connected to

2) What is the Influence Score of each of the Entities that the current Entity is connected to

3) What is the Connection Strength between the current Entity and each of the connected Entities

4) What companies is the current Entity affiliated with, and how senior are those roles.

In some embodiments, not all of these factors are taken into account. In other embodiments, other factors are taken into account or logic performed in different orders, etc.

For example, in the embodiment illustrated in FIG. 6, for each current entity (determined in block 601), the logic in blocks 602-604 is performed for each entity connected to the current entity (each connection). When there are no more connections to be processed, the logic in block 605 is performed to determine the importance of affiliations of the current entity. Then, an aggregation is computed for the current entity (block 606). These logic steps are then repeated for each current entity (the next entity to process). An aggregation may be a similar numeric addition of the scores determined at each block or may be weighted in some manner if certain attributes are more or less important than others. In other embodiments, the aggregation may be normalized to a score between a first and second value. Other forms of aggregating the determined values may be incorporated.

Also, although certain terms are used primarily herein, other terms could be used interchangeably to yield equivalent embodiments and examples. In addition, terms may have alternate spellings which may or may not be explicitly mentioned, and all such variations of terms are intended to be included.

Example embodiments described herein provide applications, tools, data structures and other support to implement a SoCap system In the following description, numerous specific details are set forth, such as data formats and code sequences, etc., in order to provide a thorough understanding of the described techniques. The embodiments described also can be practiced without some of the specific details described herein, or with other specific details, such as changes with respect to the ordering of the logic, different logic, etc. Thus, the scope of the techniques and/or functions described are not limited by the particular order, selection, or decomposition of aspects described with reference to any particular routine, module, component, and the like.

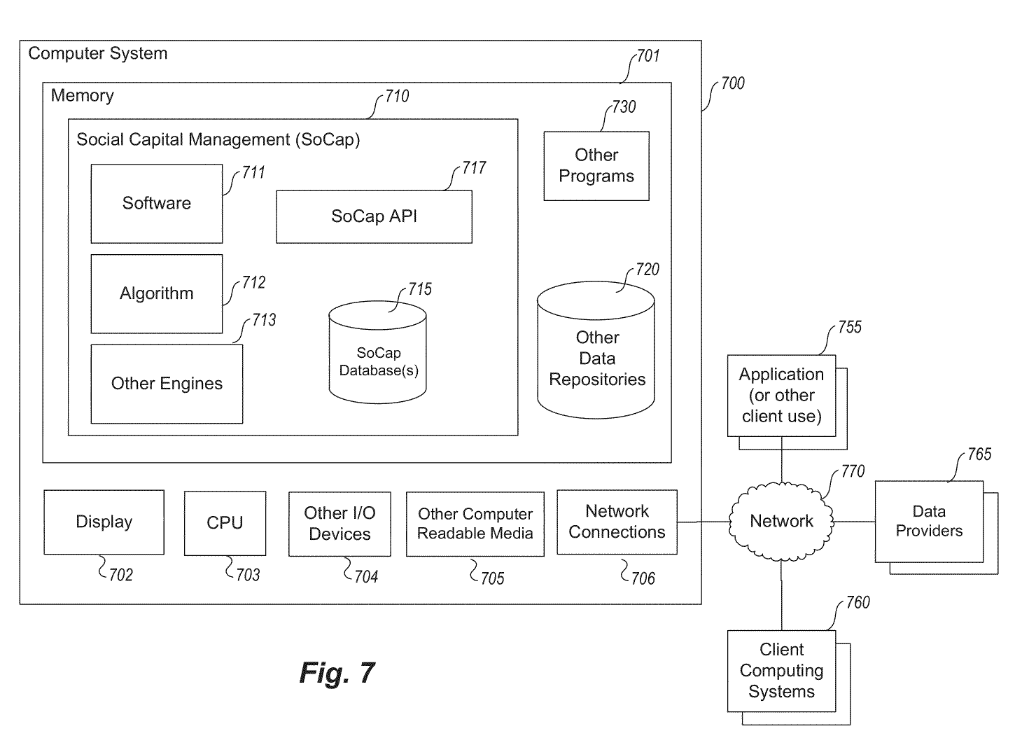

FIG. 7 is an example block diagram of an example computing system that may be used to practice embodiments of a Social Capital Management System described herein. Note that one or more general purpose virtual or physical computing systems suitably instructed or a special purpose computing system may be used to implement a SoCap. Further, the SoCap may be implemented in software, hardware, firmware, or in some combination to achieve the capabilities described herein.

The computing system 700 may comprise one or more server and/or client computing systems and may span distributed locations. In addition, each block shown may represent one or more such blocks as appropriate to a specific embodiment or may be combined with other blocks. Moreover, the various blocks of the SoCap 710 may physically reside on one or more machines, which use standard (e.g., TCP/IP) or proprietary interprocess communication mechanisms to communicate with each other.

In the embodiment shown, computer system 700 comprises a computer memory (“memory”) 701, a display 702, one or more Central Processing Units (“CPU”) 703, Input/Output devices 704 (e.g., keyboard, mouse, CRT or LCD display, etc.), other computer-readable media 705, and one or more network connections 706. The SoCap 710 is shown residing in memory 701. In other embodiments, some portion of the contents, some of, or all of the components of the SoCap 710 may be stored on and/or transmitted over the other computer-readable media 705. The components of the SoCap 710 preferably execute on one or more CPUs 703 and manage the interface for managing social capital and maximizing networking potential, as described herein. Other code or programs 730 and potentially other data repositories, such as data repository 720, also reside in the memory 701, and preferably execute on one or more CPUs 703. Of note, one or more of the components in FIG. 7 may not be present in any specific implementation. For example, some embodiments embedded in other software may not provide means for user input or display.

In a typical embodiment, the SoCap 710 includes one or more software or logic engines 711, one or more algorithms 712, or other engines 713. In at least some embodiments, the software 711 is provided external to the client system (for example as a Software As A Service Application) and is available, potentially, over one or more networks 750. Other and/or different modules may be implemented. In addition, the SoCap may interact via a network 750 with application or client code 755, one or more client computing systems 760, and/or one or more third-party information provide systems 765, such as purveyors of networking information used to form the SoCap database 715. Also, of note, the SoCap data repository 715 may be provided external to the SoCap as well, for example in a knowledge base accessible over one or more networks 750.

In an example embodiment, components/modules of the SoCap 710 are implemented using standard programming techniques. For example, the SoCap 710 may be implemented as a “native” executable running on the CPU 103, along with one or more static or dynamic libraries. In other embodiments, the SoCap 710 may be implemented as instructions processed by a virtual machine. In general, a range of programming languages known in the art may be employed for implementing such example embodiments, including representative implementations of various programming language paradigms, including but not limited to, object-oriented, functional, procedural, scripting, and/or declarative.

The embodiments described above may also use well-known or proprietary, synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously and communicate using message passing techniques. Equivalent synchronous embodiments are also supported.

In addition, programming interfaces to the data stored as part of the SoCap 710 (e.g., in the data repository 715) can be available by standard mechanisms such as through C, C++, C#, and Java APIs; libraries for accessing files, databases, or other data repositories; through scripting languages such as XML; or through Web servers, FTP servers, or other types of servers providing access to stored data. The Data Repository 715 may be implemented as one or more database systems, file systems, or any other technique for storing such information, or any combination of the above, including implementations using distributed computing techniques.

Also the example SoCap 710 may be implemented in a distributed environment comprising multiple, even heterogeneous, computer systems and networks. Different configurations and locations of programs and data are contemplated for use with techniques of described herein. In addition, the [server and/or client] may be physical or virtual computing systems and may reside on the same physical system. Also, one or more of the modules may themselves be distributed, pooled or otherwise grouped, such as for load balancing, reliability or security reasons. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, etc.) and the like. Other variations are possible. Also, other functionality could be provided by each component/module, or existing functionality could be distributed amongst the components/modules in different ways, yet still achieve the functions of an SoCap.

Furthermore, in some embodiments, some or all of the components of the SoCap 710 may be implemented or provided in other manners, such as at least partially in firmware and/or hardware, including, but not limited to one or more application-specific integrated circuits (ASICs), standard integrated circuits, controllers executing appropriate instructions, and including microcontrollers and/or embedded controllers, field-programmable gate arrays (FPGAs), complex programmable logic devices (CPLDs), and the like. Some or all of the system components and/or data structures may also be stored as contents (e.g., as executable or other machine-readable software instructions or structured data) on a computer-readable medium (e.g., a hard disk; memory; network; other computer-readable medium; or other portable media article to be read by an appropriate drive or via an appropriate connection, such as a DVD or flash memory device) to enable the computer-readable medium to execute or otherwise use or provide the contents to perform at least some of the described techniques. Some or all of the components and/or data structures may be stored on tangible, non-transitory storage mediums. Such computer program products may also take other forms in other embodiments. Accordingly, embodiments of this disclosure may be practiced with other computer system configurations.

All of the above U.S. patents, U.S. patent application publications, U.S. patent applications, foreign patents, foreign patent applications and non-patent publications referred to in this specification and/or listed in the Application Data Sheet, including but not limited to U.S. Provisional Patent Application No. 62/030,010, entitled “METHOD AND SYSTEM FOR MAINTAINING AND MANAGING SOCIAL CAPITAL,” filed Jul. 28, 2014, are incorporated herein by reference, in their entireties.

From the foregoing it will be appreciated that, although specific embodiments have been described herein for purposes of illustration, various modifications may be made without deviating from the spirit and scope of the invention. For example, the methods and systems for performing Social Capital management discussed herein are applicable to other architectures other than a web-based architecture. Also, the methods and systems discussed herein are applicable to differing application specific protocols, communication media (optical, wireless, cable, etc.) and devices (such as wireless handsets, electronic organizers, personal digital assistants, portable email machines, game machines, pagers, navigation devices such as GPS receivers, etc.).

1. A method in a computing system for displaying an interface to connect a user to one or more entities that are not yet current contacts of the user, comprising:
determining an influence score for each entity in the computing system;
determining a list of connections to the user, each such connection between the user and an entity that is already connected to the user via an application or a social network or a professional network; and
for each determined connection in the list, determining one or more top connections to the entities that are not yet current contacts of the user based in part upon the influence score of the entity that is already connected to the user, and displaying the determined one or more top connections;
wherein the computing system is configured to receive from the user a selection of one of the top connections to facilitate performing an activity to connect the user to the entity that is not yet a current contact.

2. The method of claim 1 wherein the application is an electronic mail application or a customer relationship management tool.

3. The method of claim 1 wherein the social network or the professional network is at least one of LinkedIn or Facebook.

4. The method of claim 1 wherein the influence score of a current entity is determined by aggregating a quantification of: the number of entities connected to the current entity, the influence score of each entity connected to the current entity, a strength of connection between each connected entity and the current entity, and the role of the current entity in each company affiliated with the current entity.

5. The method of claim 1, further comprising receiving an indication from the user of an engagement level with another entity.

6. The method of claim 5 wherein the indication is received via a slider control.

7. The method of claim 5 wherein the engagement level includes an indication of one of no engagement, an acquaintance, or a close friend.

8. The method of claim 1 wherein the activity to connect the user to the entity that is not yet a current contact includes at least one of: writing a compliment, checking in, holding a meeting, having coffee together, sharing a meal, or traveling together.

9. The method of claim 1 wherein a profile of the entity that is not yet a current contact is displayed without being connected.

10. The method of claim 1 wherein the influence score reflect influence of an entity in a particular community.

11. The method of claim 1 wherein the influence score is dynamically updated as the influence scores of other entities change.

12. The method of claim 1 wherein the user interface is accessed over a communications network.

13. The method of claim 1 wherein the user interface is facilitated by a web-based application.

14. A computing system, comprising:
a computer processor;
a computer memory;
a data repository storing computed influence scores for each entity accessible by the system, the influence score dynamically recomputed when an influence score of a connected entity changes; and
a social capital interface, having logic stored in the computer memory that when executed by the computer processor performs the method of claim 1 to deliver a user interface to a client device.

15. The computer system of claim 14 wherein the client device comprises a cellular phone.

16. The computer system of claim 14 wherein the social capital interface logic is provided by a software—as-a-service application.

17. A non-transitory computer readable memory medium containing instructions that, when executed by a computer processor perform the method of claim 1 to deliver a user interface to a client device.
